(19) United States
(12) Patent Application Publication
(10) Pub. No.: US 2005/0137900 A1
(43) Pub. Date: Jun. 23, 2005

(54) Methods of trading emissions credits

(75) Inventor: Kurt T. Werner, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/744,687

(22) Filed: Dec. 23, 2003

(51) Int. Cl. G06F 17/60

(52) U.S. Cl. 705/1; 705/8

(57) ABSTRACT

A method of trading emission credits wherein a technology provider transfers technology support for an emission reduction technology provider to another party; a technology applier receives the technology support and uses the technology support to apply the emission reduction technology in carrying out an industrial purpose whereby use of the emission reduction technology enables awarding of emission credits which the technology applier receives and transfers at least some of as consideration for receiving the technology support.

### FIELD OF INVENTION

The present invention relates to trading emissions credits.

### BACKGROUND

Regimes for trading emissions reduction credits have been used successfully to achieve reductions in emissions of a variety of pollutants. For example, emissions of SO₂ from electric utilities have been reduced and emissions of volatile organic chemical (sometimes referred to as “VOCs”) in southern California been reduced through emissions reduction trading programs. Emissions trading programs have been established by a variety regional and national governments, international bodies, and industry groups.

Emission credit trading programs have been proposed and formulated for a variety of pollutants, including, for example, greenhouse gases such as CO₂, CH₄, NOx, hydrofluorocarbons (“HFCs”), perfluorocarbons (“PFCs”), and SF₆; and other pollutants such as SO₂, NOx, etc.

All of these emissions trading schemes are intended to achieve overall reductions in emissions of pollutants. This is achieved by encouraging investment by pollution emitters in pollution reduction technologies where it might not otherwise make economic sense to do so without the financial benefits that can be derived by emissions trading. The opportunity for an enterprise to trade unused emissions credits for consideration is an added benefit to be obtained through investment in pollution reduction technology in addition to complying with applicable regulatory or other requirements. In addition, trading in emissions credits encourages emissions reductions across an industry or multiple industries to take place in the most cost effective manner possible. Rather than simply requiring uniform reductions in emissions across all enterprises, enterprises that are able to reduce their emissions more deeply can trade credits with other enterprises which cannot achieve similar reductions, e.g., due to constraints of older plant and equipment, different availability of raw materials, etc. As a result, greater reductions in total emissions can typically be achieved with less economic, social, and political disruption.

### SUMMARY

The present invention provides a manner of utilizing and trading in pollution emission reduction credits (sometimes referred to simply as “emission credits” or “pollution credits”) that increases the incentives to develop and to commercially enable pollution reduction technology. As a result, more effective pollution reduction technologies will be developed and pollution reduction technologies will be more widely exploited, thereby leading to reductions in pollution emissions.

In brief summary, the invention involves a technology provider, a technology applier, an emission reduction technology, technology support for said emission reduction technology, and an emission credits regime and comprises:
a) transferring technology support for the emission reduction technology from the technology provider to another party, wherein the technology support is transferred by the technology provider to another party;
b) receiving the technology support and using the emission reduction technology to carry out an industrial purpose whereby use of the emission reduction technology enables awarding of emission credits, wherein the technology applier receives the technology support and carries out the industrial purpose using the emission reduction technology such that the emission credits are awarded to the technology applier; and
c) transferring at least some of the emission credits received in conjunction with carrying out the industrial purpose as consideration for receiving the technology support, wherein the emission credits are transferred by the technology applier to another party. Typically the technology provider will receive some of the emissions credits transferred by the technology applier in consideration for providing the technology support.

In some aspects the invention provides a method for selling or facilitating selling technology support for emission reduction technology. In some aspects the invention provides a method for acquiring or facilitating acquiring such technology support.

As a result of the invention, the technology applier transfers at least some of the emission credits that it obtains in consideration for the technology support. Typically, at least some of such emission credits will be transferred to the technology provider in consideration for providing the rights to use the technology. As a result, the scope of available consideration which can be issued by the technology provider is increased and the scope of available consideration which can be received by the technology provider is increased, thereby increasing the potential incentives for it to put emission reduction technology on the market. The invention thus will tend to increase the technology support for emissions reduction technologies which is brought to market and will tend to increase the adoption of emissions reduction technologies by technology appliers.

### BRIEF DESCRIPTION OF DRAWING

FIG. 1 is a diagram of an illustrative embodiment of the invention.

FIG. 2 is a diagram of another illustrative embodiment of the invention.

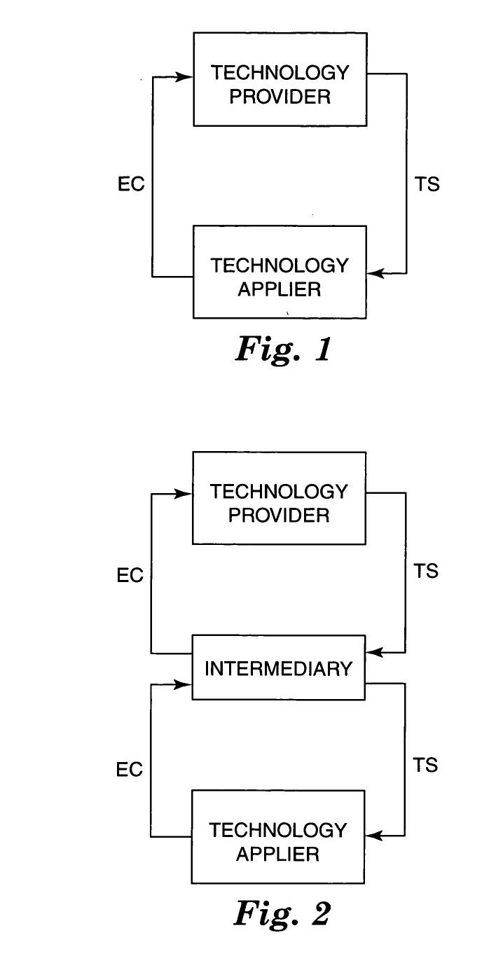

FIG. 1 illustrates one embodiment of the invention wherein a technology provider transfers technology support (TS) which is received by the technology applier. The technology applier uses the technology support and emission reduction technology in carrying out an industrial purpose, resulting in a reduction of emissions and receipt by the technology applier of emission credits (EC), e.g., under government regime, etc. (not shown). The technology applier transfers at least some of the emission credits (EC) to the technology provider in consideration for the technology support.

FIG. 2 illustrates another embodiment of the invention wherein the technology provider transfer technology support to an intermediary. The technology support is then transferred, optionally through one or more other intermediaries (not shown) to the technology applier. The technology applier uses the technology support and emission reduction technology in carrying out an industrial purpose, resulting in a reduction of emissions and receipt by the technology applier of emission credits (EC), e.g., under government regime, etc. (not shown). The technology applier transfers at least some of the emission credits (EC) in consideration for the technology support. In this embodiment, at least some of the emission credits obtained by the technology applier are ultimately transferred to the technology provider.

### DETAILED DESCRIPTION OF ILLUSTRATIVE EMBODIMENTS

The meanings of several of the terms used in this description are as follows:

“Emission credits regime” is a system of determining and awarding emission reduction credits to a party for carrying out an industrial purpose while achieving reduced emissions.

“Emission reduction technology” is a technology that can be applied in an industrial purpose to reduce the emissions of pollutants incurred in carrying out the industrial purpose.

“Industrial purpose” is any manufacturing or processing operation that yields a desired output or achieves a desired result and if carried out without emission reduction technology would result in greater emissions of pollutants than if carried out with emission reduction technology. Illustrative examples include production of energy, refining of materials, transportation of materials, manufacture, fabrication, or conversion of materials or goods, etc.

“Technology applier” means a party who utilizes technology support to apply emission reduction technology to carry out an industrial purpose.

“Technology provider” means a party who provides technology support and transfers it to another party.

“Technology support” is support for carrying out an emission reduction technology and may include one or more of authorization to practice relevant intellectual property (e.g., rights to practice or use subject matter protected by patent, patent application, trade secret, know-how, etc.), information or material support for carrying out the emission reduction technology (e.g., technical instructions, equipment, raw materials, ingredients, catalysts for implementing the emission reduction technology, etc.).

The method of the invention is carried out by a technology provider, a technology applier, and possibly one or more other parties. The technology provider and technology applier are separate legal entities, i.e., each is independently a person, corporation, partnership, or other form of business enterprise, public or private institution, or some other entity. The technology provider and technology applier may be substantially independent, i.e., if one of the technology provider or technology applier has an ownership or control interest in the other it is no more than 40% and typically no more than 10%, of the ownership or control, or if the technology provider and technology applier are subject to any common ownership or controlling interest, no more than 40% of either party, typically no more than 10%, is subject to such common ownership or control.

In addition, one or more intermediary parties may be involved in the method. For example, the technology support may be materials or equipment that can be used to reduce emissions of pollutants while carrying out an industrial purpose which are sold or leased by the technology provider to a distributor who in turn sells or leases the technology support to one or more technology appliers. In an illustrative embodiment, the technology provider may manufacture a specialty solvent which is sold through distributors to electronics manufacturers who use the solvent for cleaning devices they are making in place of other solvents which are yield greater amounts of pollutants.

The emission credits regime may be any program for awarding credits for reductions in emissions of pollutants that is organized, recognized, monitored, or operated by a government body, industry association, or other body wherein the credits may be transferred to another party. Typically the number of credits will be determined and allocated to the technology applier based in part upon the amount of reduction in emissions. The reduction in emissions may be assessed as an absolute reduction in emissions as compared to previous rates of emissions, or may be determined as a function of the volume of emissions per unit of output from the industrial purpose.

The emission credits regime may be directed to any particular pollutant. Illustrative examples include greenhouse gases such as CO₂, CH₄, NOx, hydrofluorocarbons (“HFCs”), perfluorocarbons (“PFCs”), SF₆, pollutants such as SO₂, NOx, etc.

In some instances the emission reduction technology and technology support will be created by the technology provider. For example, the technology provider may develop or invent a process for removing particulates from the exhaust streams of coal-fired furnaces, e.g., such as are used by electricity and steam generators, steel smelting operations, etc. In some embodiments, the technology provider might seek to protect rights in the emission reduction technology, the technology support, or both through one or more forms of intellectual property, e.g., by seeking one or more patents or taking appropriate measures to preserve information regarding the process as a trade secret. It will be understood, however, that it is not necessary for either of the emission reduction technology or technology support to be invented or developed by the technology provider and that neither the emission reduction technology nor technology need be considered as patentable or otherwise protectable by intellectual property in order for the present invention to be utilized. For example, the technology support provided by the technology provider may simply be a well-known raw material for use in long established, published and unpatented emission reduction technology.

The emission reduction technology is typically selected from the group consisting of: a) a method which can be carried out while carrying out the industrial purpose (e.g., process parameters and conditions, specifications for raw materials, processing know-how, product formulations, etc.), b) a material which is consumed by the technology applier while carrying out of the industrial purpose (e.g., a catalyst, raw material, etc.), or c) an apparatus used by the technology applier while carrying out the industrial purpose (e.g., a dust collector, process control equipment, reaction vessel, etc.), with the proviso that as a result of using the emission reduction technology in carrying out the industrial purpose that technology applier emits a reduced volume of pollutants than would otherwise be the case.

Depending upon the embodiment, the technology support might include at least one of the following: a) licensing rights under a patent application or patent (e.g., a patent covering the emission reduction technology), b) licensing rights to a trade secret, c) leasing or selling equipment for carrying out the emission reduction technology, or d) selling a ingredient or catalyst to be used in carrying out the emission reduction technology. Some examples of materials that can be used for industrial purposes while reducing emissions of pollutants include perfluoroketones for fire extinguishing applications, perfluoroketones for use as a cover gas in magnesium processing operations, hydrofluoroethers (“HFEs”) and HFE-blends as solvents for cleaning and coating deposition operations, HFEs as heat transfer media, C₃F₈ and C₄F₈O for use in plasma cleaning of semiconductor-making chambers.

In carrying out the industrial purpose using the technology support, the technology applier will receive emission reduction credits under the emission credits regime.

In accordance with the invention, the technology applier will transfer at least some of those emission credits in consideration for receipt of the technology support. In accordance with the invention, the technology provider will receive at least some of those pollution credits in consideration for providing the technology support.

In some embodiments, the emission credits transferred by the technology applier may be substantially the sole consideration given for the technology support by the technology applier. In other embodiments, the technology applier may transfer additional consideration in exchange for the technology support including for example one or more of monetary payment, supply of goods or services, granting rights under intellectual property, etc.

In some embodiments, the emission credits transferred to the technology provider may be substantially the sole consideration received for the technology support by the technology provider. In other embodiments, the technology provider may receive additional consideration in exchange for the technology support including for example one or more of monetary payment, supply of goods or services, granting rights under intellectual property, etc.

In some embodiments, the number of emission credits which are transferred by the technology applier will be determined as a function of the amount of technology support used by the technology applier. For example, the number of emission credits to be transferred may be determined according to a formula in correlation to the amount of a raw material (i.e., technology support) that is used, the hours of operation to which an apparatus (i.e., technology support) is used, etc.

Various modifications and alterations of this invention will become apparent to those skilled in the art without departing from the scope and spirit of this invention.

1. A method of trading emission credits comprising:
a) transferring technology support for an emission reduction technology from a technology provider to another party;
b) receiving said technology support and using said emission reduction technology to carry out an industrial purpose whereby use of said emission reduction technology enables awarding of emission credits, wherein said technology applier receives said technology support and carries out said industrial purpose using said emission reduction technology such that emission credits are awarded to said technology applier; and
c) transferring at least some of said emission credits as consideration for receiving said technology support, wherein said emission credits are transferred by said technology applier to another party.

2. The method of claim 1 wherein at least portions of said technology support are created by said technology provider.

3. The method of claim 1 wherein said emission reduction technology is selected from the group consisting of: a) a method which can be carried out while carrying out said industrial purpose, b) a material which is consumed by said technology applier during the carrying out of said industrial purpose, or c) apparatus used by said technology applier during the carrying out of said industrial purpose.

4. The method of claim 1 wherein said technology support comprises at least one of the following: a) granting rights to emission reduction matter claimed in a patent or patent application; b) granting rights to use certain technology or industrial property; c) leasing or selling equipment; or d) selling an ingredient or catalyst.

5. The method of claim 1 wherein said technology provider receives at least some of said emission credits transferred by said technology applier.

6. The method of claim 1 wherein the amount of emission credits which are transferred by said technology applier is determined at least in part based upon the amount of technology support received by said technology applier.

7. The method of claim 1 further comprising transfer of technology support through one or more intermediaries between said technology provider and said technology applier.

8. The method of claim 1 wherein said technology provider and said technology applier have no “significant” common controlling interest.

9. The method of claim 1 wherein said emission credits are essentially the sole consideration given for said technology support by said technology applier.

10. The method of claim 1 wherein said emission credits are essentially the sole consideration received for said technology support by said technology provider.

11. A method of transferring technology support for an emission reduction technology comprising:
a) transferring said technology support from a technology provider to another party;
b) receiving said technology support and using said emission reduction technology to carry out an industrial purpose whereby use of said emission reduction technology enables awarding of emission credits, wherein said technology applier receives said technology support and carries out said industrial purpose using said emission reduction technology such that emission credits are awarded to said technology applier; and
c) transferring at least some of said emission credits as consideration for receiving said technology support, wherein said emission credits are transferred by said technology applier to another party.

12. A method of acquiring technology support for an emission reduction technology comprising:
a) transferring said technology support from a technology provider to another party;
b) receiving said technology support and using said emission reduction technology to carry out an industrial purpose whereby use of said emission reduction technology enables awarding of emission credits, wherein said technology applier receives said technology support and carries out said industrial purpose using said emission reduction technology such that emission credits are awarded to said technology applier; and
c) transferring at least some of said emission credits as consideration for receiving said technology support, wherein said emission credits are transferred by said technology applier to another party.
